(19) United States
(12) Patent Application Publication
(10) Pub. No.: US 2026/0126104 A1
(43) Pub. Date: May 7, 2026

(54) HYDRAULIC SYSTEMS FOR A POWER MACHINE

(71) Applicant: Doosan Bobcat North America, Inc., West Fargo, ND (US)

(72) Inventors: Nicolas Galès, Pontchâteau (FR); Arnaud Guinee, Pontchâteau (FR)

(21) Appl. No.: 19/380,709

(22) Filed: Nov. 5, 2025

Related U.S. Application Data
(60) Provisional application No. 63/716,297, filed on Nov. 5, 2024.

(51) Int. Cl. F16H 39/02; B60K 11/06; B66F 9/065; E02F 9/22; F15B 11/17; F15B 21/00

(52) U.S. Cl. CPC F16H 39/02; B60K 11/06; B66F 9/0655; E02F 9/2203; E02F 9/2253; E02F 9/226; E02F 9/2275; E02F 9/2292; E02F 9/2296; F15B 11/17; F15B 21/005

(57) ABSTRACT

A hydraulic system for a power machine can include a hydrostatic drive motor, a hydrostatic drive pump that is in communication with the hydrostatic drive motor via a hydrostatic drive circuit. A drain case can include one or more of the hydrostatic drive motor or the hydrostatic drive pump. A venturi device can include a main flow inlet in communication with the hydrostatic drive circuit, a main flow outlet, and a suction inlet in communication with the drain case. The hydraulic system can further include a heat exchanger, a tank, and an assist pump that includes an assist pump inlet in communication with the main flow outlet of the venturi device and an assist pump outlet in communication with the heat exchanger.

### CROSS-REFERENCE TO RELATED APPLICATIONS

This application claims the benefit of U.S. provisional application No. 63/716,297, filed 5 Nov. 2024, which is hereby incorporated by reference in its entirety as though fully set forth herein.

### BACKGROUND

This disclosure is directed toward power machines. More particularly, the present disclosure is directed to a hydraulic system for power machines. Power machines, for the purposes of this disclosure, include any type of machine that generates power to accomplish a particular task or a variety of tasks. One type of power machine is a work vehicle. Work vehicles are generally self-propelled vehicles that have a work device (e.g., a lift arm or an implement) that can be manipulated to perform a work function. Work vehicles include telehandlers, loaders, excavators, utility vehicles, tractors including compact tractors, and trenchers, to name a few examples. Other types of power machines can include mini-loaders (e.g., mini track loaders), and mowers.

Different types of power machines, including telehandlers, can include a power system powered by a power source to operate one or more components of the power machine. For example, some power machines include hydraulic systems that are powered by an internal combustion engine to operate tractive elements of the power machine.

The discussion above is merely provided for general background information and is not intended to be used as an aid in determining the scope of the claimed subject matter.

### SUMMARY

According to some aspects of the disclosure, a hydraulic system for a power machine can be provided. The hydraulic system can include a hydrostatic drive motor, a hydrostatic drive pump that is in communication with the hydrostatic drive motor via a hydrostatic drive circuit. A drain case can include one or more of the hydrostatic drive motor or the hydrostatic drive pump. A venturi device can include a main flow inlet in communication with the hydrostatic drive circuit, a main flow outlet, and a suction inlet in communication with the drain case. The venturi can operate to provide suction to the drain case via the suction inlet during flow of fluid from the main flow inlet to the main flow outlet. The hydraulic system can further include a heat exchanger, a tank, and an assist pump that includes an assist pump inlet in communication with the main flow outlet of the venturi device and an assist pump outlet in communication with the heat exchanger. The assist pump can operate to receive flow from the main flow outlet of the venturi device and provide pressurized flow to the tank via the heat exchanger.

According to some aspects of the disclosure, a power machine can include a power source and a hydraulic drive system that includes a hydrostatic drive circuit, a drive pump powered by the power source, a drive motor powered by the drive pump via the hydrostatic drive circuit, and a drain case that includes the drive motor. The power machine can include a venturi device that includes a main flow inlet, a main flow outlet, and a suction inlet in communication with the drain case. A heat exchanger and a tank can be provided. The power machine can include an assist pump that is powered by the power source and includes an assist pump inlet supplied by the main flow outlet of the venturi device and an assist pump outlet in communication with the heat exchanger. The hydrostatic drive system can supply flow to the main flow inlet of the venturi device, to draw fluid from the drain case via the suction inlet of the venturi device. The assist pump can route the fluid drawn from the drain case to the tank, via the heat exchanger.

According to some aspects of the disclosure, a method of operating a power machine can be provided. A hydrostatic drive pump of the power machine can be operated to provide flow of fluid within a hydrostatic drive circuit. A portion of the fluid can be routed from the hydrostatic drive circuit to a main flow inlet of a venturi case, to generate suction at a suction inlet of the venturi device and thereby induce fluid from a drain case of the hydrostatic drive circuit to flow from a main flow outlet of the venturi device. Using an assist pump, the flow from the main flow outlet of the venturi device can be pressurized to flow through a heat exchanger to tank.

This Summary and the Abstract are provided to introduce a selection of concepts in a simplified form that are further described below in the Detailed Description. This Summary is not intended to identify key features or essential features of the claimed subject matter, nor are they intended to be used as an aid in determining the scope of the claimed subject matter.

### BRIEF DESCRIPTION OF THE DRAWINGS

The following drawings are provided to help illustrate various features of non-limiting examples of the present disclosure and are not intended to limit the scope of the disclosure or exclude alternative implementations.

FIG. 1 is a block diagram illustrating functional systems of an example power machine according to some examples of the disclosed technology.

FIG. 2 is a block diagram of an example configuration of the power machine of FIG. 1.

FIG. 3 is a perspective view of a telehandler that includes the systems represented by the block diagram of FIG. 2.

FIG. 4 is a partial top view of a power conversion system of the telehandler of FIG. 3

FIG. 5 is a diagrammatic illustration of an example hydraulic system for a power machine, including the power conversion system of FIG. 4.

### DETAILED DESCRIPTION

The concepts disclosed in this discussion are described and illustrated by referring to exemplary implementations of the disclosed technology. These concepts, however, are not limited in their application to the details of construction and the arrangement of components in the illustrative examples and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Conventional power machines may be configured to operate a power conversion system (e.g., a transmission system) by providing power from internal combustion engines (e.g., diesel engines). Conventionally, rotational power from an engine can power a drive pump of a hydrostatic transmission system, which can pump flow of pressurized hydraulic fluid (e.g., oil) to operate a corresponding drive motor. However, operation of these types of systems may result in the hydraulic fluid leaking from the hydraulic circuit and accumulating in various housings (e.g., a drain case of the drive motor). This can contribute to a decreased efficiency of the drive motor and the drive system overall. For example, when the drive motor rotates at a high speed, churning losses in the hydraulic fluid may occur and contribute to a large amount of power loss of the drive system.

Examples of the present disclosure can address these problems, for example, by providing a case drain system to discharge accumulated hydraulic fluid (e.g., leaked or excess oil) from a hydrostatic drive system to tank. In particular, a case drain line can include a venturi device to suction hydraulic fluid out of a drain case for a drive motor. The venturi device, for example, can be powered by a pressurized flow from the corresponding hydrostatic drive circuit, or by other flows as detailed below.

Because the hydraulic fluid may be hot, a heat exchanger (e.g., a cooler) can be provided to lower the temperature of the hydraulic fluid prior to the fluid being discharged to the tank. However, the heat exchanger may cause a backpressure that may oppose operation of the venturi. Correspondingly, in some examples, an assist pump can be provided between the venturi device and the heat exchanger. Such an arrangement can help to increase a vacuum draw on a drain case or otherwise pressurize flow from the venturi device sufficiently to overcome the backpressure of the cooler. Thus, the assist pump can help direct hydraulic fluid into and through a case drain line with generally greater efficiency than conventional systems.

In some examples, additional hydraulic fluid can be provided from an implement circuit, separate from a hydrostatic drive circuit, to provide sufficient flow through an assist pump or a heat exchanger. Accordingly, motor churning and or formation of air bubbles along the hydraulic line can be reduced. In some cases, flow from the implement circuit can additionally (or alternatively) provide charge flow to the hydrostatic circuit. Further, flow paths can be provided in some operational modes for supplemental cooling of fluid from the implement circuit by the heat exchanger for the drain oil.

Therefore, the disclosed technology can assist with reducing the level and pressure of hydraulic fluid within a case drain or other enclosure, with correspondingly enhanced efficiency of the hydraulic motor or other devices.

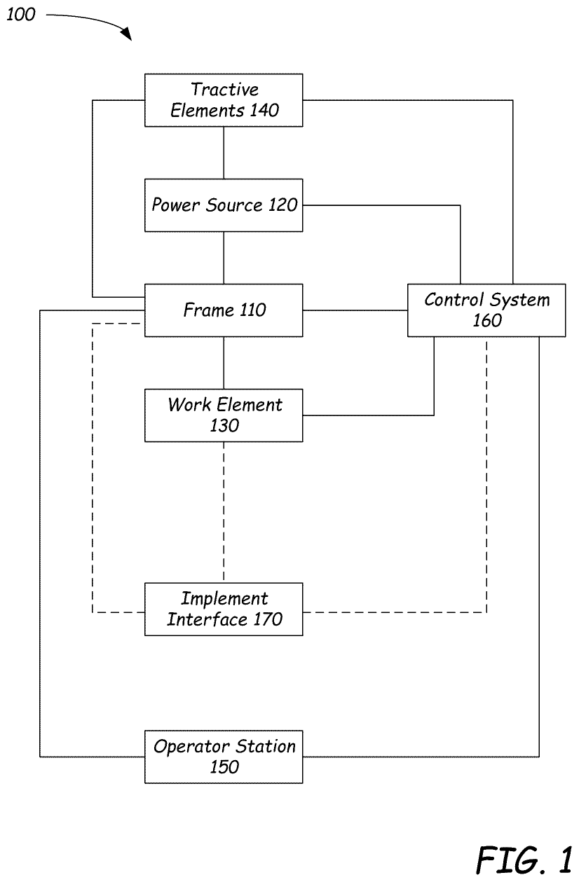

Although examples herein focus particularly on telehandlers—e.g., diesel-hydraulic telehandlers—implementations of the disclosed technology can be practiced on a variety of power machines with a variety of ground-engaging elements. In this regard, FIG. 1 is a block diagram that illustrates the basic systems of a power machine 100, which can be any of a number of different types of power machines and upon which the embodiments discussed below can be advantageously incorporated. The block diagram of FIG. 1 identifies various systems on power machine 100 and the relationship between various components and systems. In particular, the power machine 100 has a frame 110, a power source 120, a workgroup work element 130 and tractive work elements 140. The workgroup work element 130 can be operated to perform work tasks (e.g., mowing, digging, cutting, grading, etc.) and the tractive work elements 140 can be operated move the power machine over a support surface. In the illustrated example, the power machine 100 also includes an operator station 150 that provides an operating position for controlling the work elements of the power machine. In some examples, however, no operator station may be included.

A control system 160 is provided to interact with other systems of the power machine 100 to perform various tasks, including in response to control signals provided by an operator. For example, the control system 160 can be an integrated or distributed architecture of one or more controllers (e.g., one or more processor devices and one or more memories) that are collectively configured to receive operator input or other input signals (e.g., sensor data) and to output commands accordingly for power machine operations (e.g., workgroup operations, tractive operations, etc.).

Some power machines can include dedicated work elements, including mower decks, cutting or drilling implements, buckets, grading blades, and others as variously known in the art. In some cases, work elements can be interchanged on a particular power machine (e.g., as attachable implements that can be supported by a lift arm, or otherwise). In this regard, for example, the power machine 100 as illustrated includes an implement interface 170, which provides a connection between the frame 110 or the work element 130 and an attachable implement. In some cases, the implement interface 170 can be a direct connection to secure an implement directly to the frame 110 or to the work element 130 (e.g., can be a pinned connection directly to a lift arm). In some cases, the implement interface 170 can include a linkage or other support structure, or can be formed as an implement carrier (e.g., which may be configured to secure and support various implements, and may itself be controllably movable relative to the frame 110 or the work element 130). In some examples, the implement interface 170 can be a pinned or other connection that secures a mower deck to a movable support structure, so that the mower deck can be supported at selected heights relative to the frame 110 (and the ground).

In some examples, the frame 110 can be rigid (e.g., formed from a single member, a weldment, or other unified structure). In some examples, at least one portion of the frame 110 may be movable relative to another. For example, excavators can have an upper frame portion that rotates with respect to a lower frame portion, and some power machines can include articulated frames that are pivotable about one or more vertical (or other) axes. Articulated frames, for example, can be used to implement steering operations, provide improved following of terrain, or otherwise.

The frame 110 supports the power source 120, which can provide power to the work element 130 or the tractive elements 140. In some cases, the power source 120 can provide power for use by an implement attached at the implement interface 170. In some examples, power from the power source 120 can be provided directly to the work element 130, the tractive elements 140, or implement interfaces 170 (e.g., via direct mechanical or electrical connection). In some examples, power from the power source can be provided indirectly to the work element 130, the tractive elements 140, or the implement interfaces 170 (e.g., may be transferred via hydraulic operations, or a combination of electrical and hydraulic operations). In some examples, the control system 160 can control routing of power from the power source 120 to other systems (e.g., via a system of electronic, hydraulic, electro-hydraulic, or other control devices, including as generally known in the art).

In some examples, the power source 120 can include an engine (e.g., an internal combustion engine). In some examples, the power source 120 can include an electrical power source (e.g., a battery, a capacitor, a fuel cell, etc.). In some examples, hybrid power sources can be provided (e.g., with a combination of an engine and an electrical power source). In some examples, a power conversion system can be provided to convert power from the power source 120 into other forms useable by the work element 130, the tractive elements 140, or an implement at the implement interface 170. For example, a hydraulic system can be used to convert rotational output from the power source 120 into hydraulic power (e.g., to power hydrostatic or other operations). Similarly, an electrical system can be used to convert electrical output from the power source 120 into non-electrical power (e.g., rotational mechanical power, or hydraulic power via a coupled hydraulic system).

For simplicity of presentation, FIG. 1 shows the work element 130, but various examples can include various numbers of work elements. In some examples, as also discussed above, work elements can include mower decks or other similar equipment. In some examples, work elements can include lift arm assemblies or other similar systems. The tractive elements 140 are a special case of work elements and may be provided in various number and configuration. In some examples, tractive elements can be arranged and controllable for independent operation and can be steerable in some cases. In some examples, one or more tractive elements on a first side of the power machine 100 may be separately controllable from one or more tractive elements on a second side of the power machine 100 (e.g., controllable for rotation in opposite directions for “skid steer” operation). Tractive elements can be, for example, wheels attached to an axle, track assemblies, or other assemblies of known configurations to convey tractive power from the frame 110 to a supporting surface.

In some examples, the tractive elements 140 can be rigidly mounted to the frame 110 so as to be limited to rotation about one or more corresponding axles. In some examples, the tractive elements 140 can be pivotally mounted to the frame 110. In some power machines, including zero-radius turn mowers, one or more caster wheels or similar devices can be used in combination with rigidly mounted tractive elements, with the rigidly mounted tractive elements provide tractive power and allowing the power machine to be steered via implementation of different ground-engaging speeds at tractive elements on opposing sides of the power machine. Such an arrangement is referred to herein as a zero-radius turn configuration and can in particular be implemented on mowers, as further discussed below.

In some power machines, the operator station 150 is defined by an enclosed or partially enclosed cab. In some examples, the operation station 150 can include a standing or other platform (e.g., without overhead enclosure). In some examples, the operator station 150 can be a remote station (e.g., as provided by a remote control device not attached to the frame 110). In some examples, the operator station 150 can be supported by the frame 110 by accessible by operators that are not (e.g., by an operator walking behind the power machine 100).

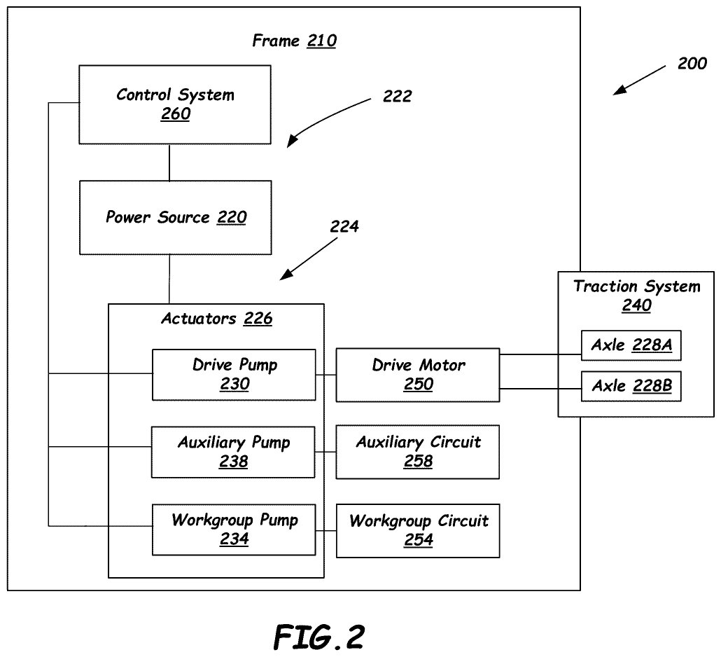

FIG. 2 schematically illustrates an example of an electrically powered telehandler 200, which is one particular example of the power machine 100 illustrated in FIG. 1. To that end, features of the telehandler 200 described below include reference numbers that are generally similar to those used in FIG. 1. For example, the telehandler 200 has a frame 210, just as power machine 100 has a frame 110. The telehandler 200 should not be considered limiting especially as to the description of features that telehandler 200 may have described herein that are not essential to the disclosed examples and thus may or may not be included in power machines other than the telehandler 200 upon which the examples disclosed below may be advantageously practiced. Unless specifically noted otherwise, examples disclosed below can be practiced on a variety of power machines, with the telehandler 200 being only one of those power machines. For example, some or all of the concepts discussed below can be practiced on many other types of work vehicles such as various other loaders, excavators, trenchers, and dozers, to name but a few examples.

The frame 210 of the telehandler 200 supports a power system 222 that can generate or otherwise provide power for operating various functions on the power machine. In particular, the power system 222 can include a power source 220 configured to supply power for power machine operations, as well as a power conversion system 224 arranged to utilize the power from the power source 220 for useful power machine operations.

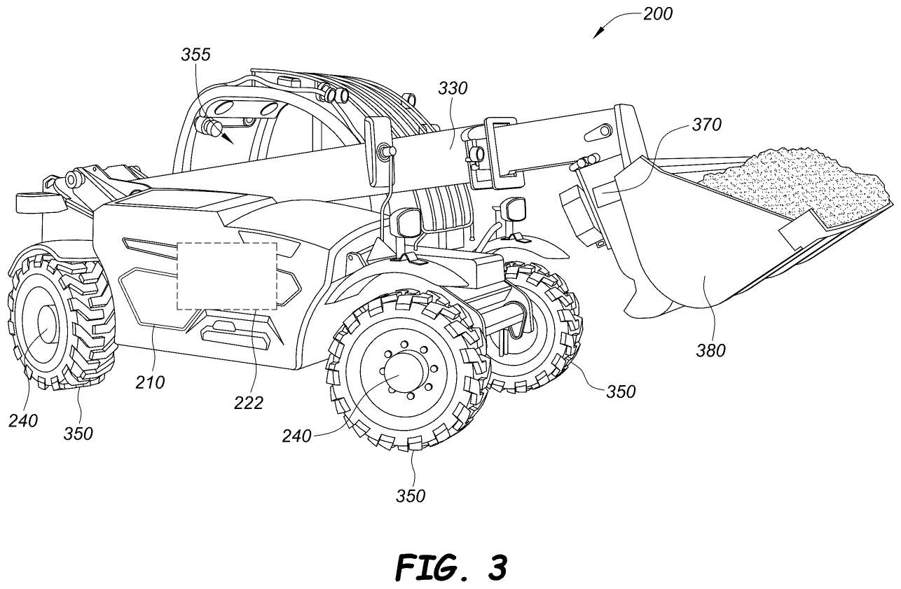

In particular, the power conversion system 224 of the telehandler 200 can include various components, including mechanical transmissions, hydraulic systems, various motors or other actuators, and the like. In some examples, the power conversion system 224 of the telehandler 200 includes one or more actuators 226, which can be powered by the power source 220 and can be selectively controllable (e.g., via the control system 260) to provide a power to various work elements of the telehandler 200. In some examples, as further discussed below, the actuators 226 can include a drive pump 230 (e.g., a hydrostatic drive pump), which may be connected to a drive motor 250 (e.g., a hydrostatic drive motor), which may provide power to axles 228A, 228B. Further, an auxiliary pump 238 (e.g., a hydraulic pump) can be powered to provide pressurized hydraulic fluid to one or more auxiliary functions within an auxiliary circuit 258 of the telehandler 200 (e.g., braking, steering, oil-cooling flow, pre-charge flow, etc.). Additionally, a workgroup pump 234 (e.g., a hydraulic pump) can be actuated to provide pressurized hydraulic fluid to one or more work implements within a workgroup circuit 254 of the telehandler 200 (e.g., hydraulic actuators to raise and lower a lift arm, extend or retract a telescoping boom, tilt an implement carrier, etc.). FIG. 3 illustrates an example external configuration of the telehandler 200. As noted above, the frame 210 of the telehandler 200 supports the power system 222, e.g., as shown in block diagram form, located within the frame 210. The frame 210 also supports a work element in the form of a lift arm assembly 330 (e.g., including a telescoping boom) that is powered by the power system 222 and that can perform various work tasks. As the telehandler 200 is a work vehicle, the frame 210 also supports the traction system 240, which is also powered by power system 222 and can propel the power machine over a support surface. The lift arm assembly 330 in turn supports an implement (e.g., accessory) interface 370 that can receive and secure various implements to the telehandler 200 for performing various work tasks. In some examples, the implement interface 370 (or other sub-system) can include power couplers, to which an implement can be coupled to receive hydraulic or electric power from the power system 222.

The lift arm assembly 330 shown in FIG. 3 is one example of many different types of lift arm assemblies that can be attached to a power machine such as telehandler 200 or other power machines on which examples of the present discussion can be practiced. The lift arm assembly 330 is moveable using actuators (e.g., hydraulic cylinders), to change position of the lift arm assembly 330 along a lift path with respect to the frame 210 (e.g., to raise and lower the lift arm assembly as desired). Other lift arm assemblies can have different geometries and can be coupled to the frame of a loader in various ways to provide lift paths. For example, some lift arm assemblies are configured to provide a vertical lift path, while others are configured to provide a radial lift path. Some lift arm assemblies can have an extendable or telescoping portion. Some power machines can have a plurality of lift arm assemblies attached to their frames, with each lift arm assembly being movable independent of the other(s). In one particular example, the lift arm assembly 330 of the telehandler 200 may be offset (e.g., laterally offset) to one side of the telehandler 200, with an operator station 355 arranged laterally from the lift arm assembly 330. Unless specifically stated otherwise, none of the inventive concepts set forth in this discussion are limited by the type or number of lift arm assemblies that are coupled to a particular power machine.

Some lift arms, including lift arms on excavators, may have portions that are controllable to pivot with respect to another segment instead of moving in concert (i.e., along a pre-determined path). Some power machines have lift arm assemblies with a single lift arm, such as is known in excavators, in some loaders, and in other power machines.

Generally, implements can be located forward of a front end of a frame of the telehandler 200 (or at other locations), including implements that include or provide any suitable accessory for the telehandler 200. For example, an implement 380 can be configured as a bucket (e.g., as shown), one or more forks, or a man lift, but is not so limited and may be nearly any variety of accessory that may be utilized and/or driven by the telehandler 200. Generally, implements have a complementary machine interface that is configured to be engaged with the implement interface 370 in an operational configuration. Further, various implement power couplers can be included to provide hydraulic or electrical signals to or from an associated implement (e.g., the implement 380).

As mentioned above, the telehandler 200 includes the operator station 355, from which an operator can manipulate various control devices to cause the power machine to perform various work functions. In some examples, the operator station 355 includes an operator seat and a plurality of operation input devices, including control levers and a steering wheel (e.g., control devices) that an operator can manipulate to control various machine functions, including as steering functions, drive functions, and auxiliary hydraulic functions (i.e., pressurized hydraulic flow made selectively available to an operably coupled implement). Operator input devices can include various human-machine interfaces including buttons, switches, levers, sliders, pedals, touchscreens, and the like that can be stand-alone devices such as hand-operated levers or foot-operated pedals, incorporated into hand grips, or incorporated into display panels, which may be included on a dashboard, including programmable input devices. Actuation of operator input devices can generate signals in the form of electrical signals, hydraulic signals, or mechanical signals. Signals generated in response to operator input devices are provided to various components on the power machine for controlling various functions on the power machine (e.g., to or via one or more electronic controllers of a larger electronic control system). Among the functions that can be controlled via operator input devices on telehandler 200 include control of the traction system 240, the lift arm assembly 330, the implement interface 370, and providing signals to any implement that may be operably coupled to the implement.

Other power machines, including walk behind power machines may not have a cab nor an operator compartment, nor a seat. The operator position on such power machines is generally defined relative to a position where an operator can access and manipulate relevant operator input devices.

Various power machines that can include or interact with the examples discussed below can have various different frame components that support various work elements. The frame 210 discussed herein can include many elements, however the frame 210 is not the only type of frame that a power machine on which the disclosed technology can be practiced can employ. For example, the frame 210 of telehandler 200 can include an undercarriage or lower portion of the frame 210 and a mainframe or upper portion of the frame 210 that is supported by the undercarriage. The main frame of telehandler 200, in some examples is attached to the undercarriage such as with fasteners or by welding the undercarriage to the main frame. Alternatively, the main frame and undercarriage can be integrally formed. The frame 210 also supports a set of tractive elements in the form of wheels 350 at the front and back of both sides of the telehandler 200.

The description of power machine 100 and telehandler 200 above is provided for illustrative purposes, to provide illustrative environments on which the examples discussed below can be practiced. While the examples discussed can be practiced on a power machine such as is generally described by the power machine 100 shown in the block diagram of FIG. 1 and more particularly on the telehandler 200, unless otherwise noted or recited, the concepts discussed below are not intended to be limited in their application to the environments specifically described above.

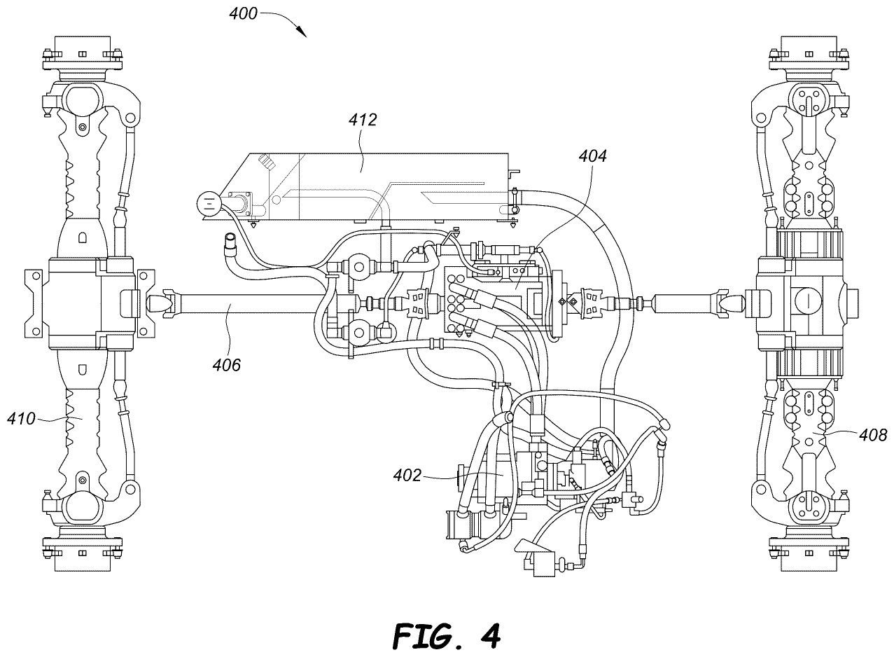

FIG. 4 illustrates an example power conversion system 400 (e.g., a transmission system) that can be implemented on a power machine such as the power machine 100, the telehandler 200 or other power machines on which examples of the present discussion can be practiced. In particular, the power conversion system 400 can include a drive pump 402 (e.g., a hydrostatic drive pump) that is controllably or constantly powered by a power source. For example, with a power source configured as a diesel engine, the drive pump 402 (and other pumps, as discussed below) can be directly powered by the engine at a rotational speed equal to the rotational speed of the engine. The drive pump 402 can be hydraulically connected to a drive motor 404 (e.g., a hydrostatic drive motor) to provide power to a front axle 408 and a rear axle 410. For example, the drive pump 402 can deliver hydraulic fluid to the drive motor 404 via a hydrostatic drive circuit 552 to convert hydraulic energy from the drive pump 402 into rotational motion to turn a drive shaft 406 that extends to (or across) the drive motor 404.

In the illustrated example, the drive shaft 406 can include a first portion that is connected to a first side of the drive motor 404 and to the front axle 408. The drive shaft 406 can also include a second portion that is connected to a second side of the drive motor 404 and to the rear axle 410. The first and second portions of the drive shaft 406 can be generally aligned, and the drive motor 404 may correspondingly not require a gearcase. However, in other configurations, other transmission arrangements are possible.

In some cases, the drive motor 404 can reside in a motor housing, or the drive motor 404 can include a plurality of motors. For example, two or more motors can be provided to increase a capacity to accelerate the drive motor 404 at a faster rate or to provide a greater amount of torque across a range of speeds. The plurality of motors may be provided in a common motor housing in some examples.

In some implementations, a tank 412 can be in fluid communication with various parts of the power conversion system 400. The tank 412 can store hydraulic fluids to provide flow to the power conversion system 400 and also generally provide a repository to remove excess oil from the power conversion system 400 (e.g., a case drain). For example, the tank 412 can be connected to the motor housing of the drive motor 404 to receive the oil that is drained from the motor housing. Advantageously, the drive motor 404 can thus operate in a dry motor housing, with correspondingly enhanced performance and efficiency of the drive motor 404.

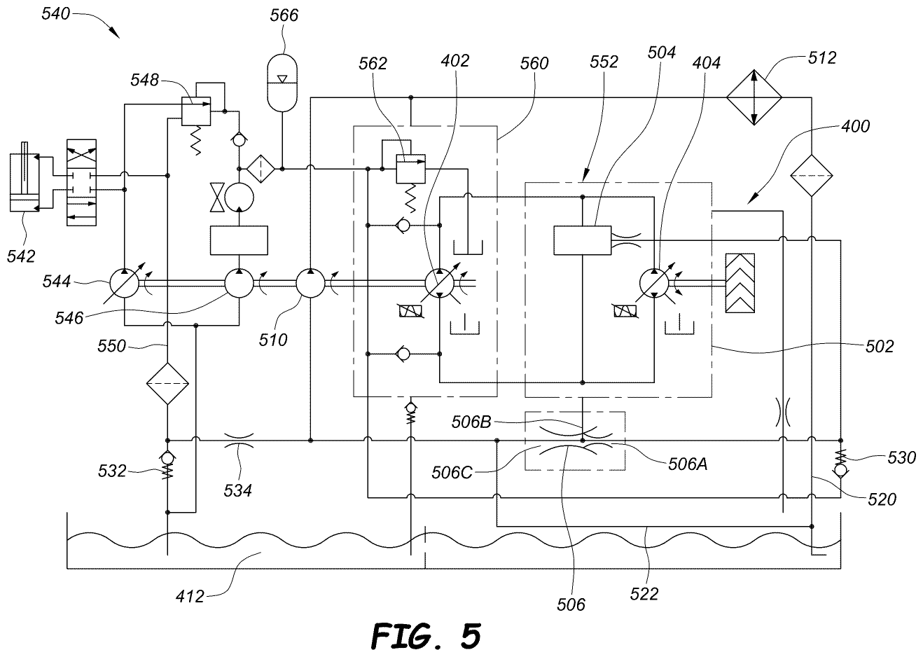

FIG. 5 illustrates an example hydraulic diagram for a power machine that includes an implementation of the power conversion system 400. As mentioned previously, the drive motor 404 can be powered by the drive pump 402 (e.g., to power a tractive system). The drive pump 402 can be operatively (e.g., mechanically) connected to a shaft or other rotational output powered by a power source (not shown in FIG. 5), along with various other pumps. Accordingly, a diesel engine or other power source can provide power to operate various functions of the power machine.

For example, a workgroup pump 544 (e.g., a variable displacement pump) (e.g., an implement pump) can be provided to deliver hydraulic power to a workgroup cylinder 542, or other workgroup actuator, for operation of one or more workgroup implements. An auxiliary pump 546 (e.g., a fixed displacement pump) can also be provided to operate a cooling fan for the engine or various other auxiliary systems (not shown). As further discussed below, the auxiliary pump 546 can also serve as a charge pump for the power conversion system 400 in some cases. Further, an assist pump 510 (e.g., a fixed displacement pump) can be provided to route hydraulic fluid that is drained from the drive motor 404 to be cooled by a heat exchanger 512.

In particular, a drain case 502 can be provided to catch hydraulic fluid that leaks from the drive motor 404 or other sources. In different examples, the drain case 502 can be a motor housing or can surround a motor housing. A hydrostatic circuit that includes the drive pump 402 and the drive motor 404 can correspondingly pass into and out of the drain case 502. As implemented, the power conversion system 400 can also include a shuttle valve 504 connected to the hydrostatic drive circuit 552. The shuttle valve 504 can selectively route lower pressure hydraulic fluid from the hydrostatic drive circuit 552 for operation of the drainage system, as further discussed below.

Continuing, a venturi device 506 (e.g., of various known designs) can be provided to induce the discharge of hydraulic fluid from the drain case 502. For example, a main flow inlet 506A for flow to power the venturi device 506 can be in communication with an outlet of the shuttle valve 504. Accordingly, motive flow for operation of the venturi device 506 can generally be supplied by the hydrostatic drive circuit 552 (e.g., a low-side hydrostatic pressure). Further, a flow path through the venturi device 506 can include a portion with a decreased cross-sectional area, so that local fluid pressure can be correspondingly decreased. A suction inlet 506B in communication with this reduced pressure area can be connected to the drain case 502, so that the resulting suction can pull accumulated hydraulic fluid from the drain case 502 into the flow through the venturi device 506. Although a venturi device may provide a low-footprint, reliable source of suction in this regard, other arrangements may similarly employ other vacuum devices (e.g., a vacuum pump) to draw hydraulic fluid from the drain case 502.

As generally noted above, an inlet of the assist pump 510 can be arranged in communication with an outlet 506C of the venturi device 506. Further, an outlet of the assist pump 510 can be in communication with the heat exchanger 512, to pressurize hydraulic fluid from the outlet 506C of the venturi device 506 and direct the pressurized flow through the heat exchanger 512 to the tank 412. As noted above, the heat exchanger 512 may impose a significant amount of backpressure, and it may accordingly be difficult for the venturi device 506 alone to maintain flow of hydraulic fluid through the heat exchanger 512. The assist pump 510, as positioned between the venturi device 506 and the heat exchanger 512, can provide a pressure boost to flow from the venturi device 506 to overcome the backpressure of the heat exchanger 512. Thus, relatively hot fluid from the drain case 502 can be routed through the heat exchanger 512, and through a filter as needed, then to a primary drain line 520 for return to the tank 412. Therefore, a combination of the venturi device 506 and the assist pump 510 can help to maintain a relatively dry condition in the drain case 502, with corresponding improvements in efficiency, by routing hydraulic fluids from the drain case 502 to be cooled and then returned to the tank 412.

In some implementations, an intermediate check valve 530 (or other one-way valve) can be provided to achieve a desired directional flow of hydraulic fluid. In some cases, this arrangement can help to ensure operation of the venturi device 506 despite decreased flow from the hydrostatic circuit. For example, when the hydrostatic drive system of the power conversion system 400 is operating in neutral or idle, flow from the shuttle valve 504 (or otherwise from the hydrostatic circuit) may be insufficient to ensure operation of the venturi device 506. As a consequence, fluid may drain from the drive motor 404 to accumulate in the drain case 502, or may even be sucked from the tank 412 into the drain case 502. Upon switching out of neutral or idle, an initial drainage period may then correspondingly be required, before the hydrostatic system can operate at full efficiency.

To address this issue, the intermediate check valve 530 can connect an additional flow source to the inlet 506A of the venturi device 506. For example, the outflow of the auxiliary pump 546 can be routed through the check valve 530 in the example shown. Thus, flow from the auxiliary pump 546 can supplement flow from the shuttle valve 504, as needed, to ensure desired operation of the venturi device 506. In particular, the intermediate check valve 530 is shown as a biased check valve with a spring pressure of 5 bar, although other arrangements are possible.

In some cases, the auxiliary pump 546 can also (or alternatively) provide charge flow for the hydrostatic drive circuit 552. For example, inlets at both sides (hydraulically) of the drive pump 402 can be provided, as shown, along a flow line that also supplies the main flow inlet 506A of the venturi device 506.

In some cases, supplemental charge flow for the hydrostatic drive circuit 552 or for the venturi device 506 can be provided by one or more other pumps (e.g., from an auxiliary or workgroup circuit 540). For example, flow from the workgroup pump 544 can power the workgroup cylinder 542 to perform various work functions and can also be routed to as charge flow for the hydrostatic drive circuit 552 or as an inlet flow for the venturi device 506. In particular, in the illustrated example, outflow from the workgroup pump 544 can be combined with flow from the auxiliary pump 546, via a pressure reducing valve 548 arranged to enforce a maximum pressure of 18 bar (or another desired setting). Thus, in some cases, flow from the workgroup pump 544 can be directed as charge flow for the hydrostatic drive circuit 552 or as supplemental inlet flow for the venturi device 506 (via the check valve 530). In some examples, the workgroup pump 544 may be a load sensing pump that can maintain a desired level of fluid pressure at an outlet of the workgroup pump 544, although other configurations are possible.

In some examples, an accumulator 566 can be provided as a buffer for charge flow into the hydrostatic drive circuit 552 or for supplemental flow to the venturi device 506. For example, the accumulator 566 in the illustrated example is downstream of the pressure reducing valve 548 and the auxiliary pump 546, and upstream of the charge inlets into the hydrostatic drive circuit 552 and the main flow inlet 506A of the venturi device 506. The accumulator 566 can thus accumulate pressurized fluid from either of the pumps 544, 546 to further supplement charge or venturi flow as needed (e.g., during transition to maximum displacement at the drive pump 402 or drive motor 404, or at other times).

In some examples, a pressure relief valve 562 can further control pressure of the hydraulic fluid for charge or venturi flow, with a setting generally greater than the setting of the pressure reducing valve 548 (e.g., with a setting of 19 bar as shown). Accordingly, if hydraulic fluid received from the pumps 544, 546 or the accumulator is at an appropriate pressure level, then the hydraulic fluid may continue to flow to the main flow inlet 506A of the venturi device 506 (e.g., through the intermediate valve 530) or to charge the hydrostatic circuit. However, if the hydraulic fluid exceeds the desired pressure level, the pressure relief valve 562 can open to discharge the hydraulic fluid to the tank 412.

During some operating conditions, other flow paths can provide additional flow to or from tank, relative to the venturi device 506 and the assist pump 510, to ensure optimal operation of the system overall. For example, in some implementations, a discharge valve 532 along a discharge path 550 for the workgroup circuit can require a particular pressure drop (e.g., 0.75 bar) between the tank 412 and the outflow from the workgroup cylinder 542 or from the workgroup pump 544 (e.g., via the intervening pressure reducing valve 548). For example, the outlet of the workgroup pump 544 can be in fluid communication with the assist pump 510 (via and downstream of a main control valve for control of the workgroup cylinder 542) in parallel with flow from the outlet 506C of the venturi device 506. In combination with the inclusion of an orifice 534, this arrangement can permit flow of hydraulic fluid from the workgroup systems to the assist pump 510. Thus, for example, cavitation can be prevented at the assist pump 510 despite reduced flow from the venturi device 506. In some cases, the main control valve can be controlled to direct flow of hydraulic fluid from the workgroup systems to the tank 412. Further, the diverted fluid from the workgroup systems can be cooled by the heat exchanger 512 before returning to the tank 412, along with the hydraulic fluid from the venturi device 506, which may result in overall improvement in thermal performance. This cooling arrangement, for example, may be particularly beneficial during operation of the workgroup system at high loading—and high heating—while the drive system operates at low speed or idle.

Similarly, additional flow can be drawn from the tank 412 through a recirculation line 522 that branches from the primary drain line 520. For example, the recirculation line 522 can provide cooled fluid from the heat exchanger 512 to a location that is hydraulically between the assist pump 510 and both the venturi device 506 and the orifice 534. Accordingly, the assist pump 510 may recirculate an amount of already cooled fluid, as drawn via the recirculation line 522, in the case that hydraulic fluid flow through the orifice 534 and through the venturi device 506 may not be sufficient to run the assist pump 510 without cavitation. Thus, appropriate operation of the assist pump 510 can be ensured for a variety of hydraulic conditions, while recirculation of previously cooled fluid from the recirculation line 522 can be provided as needed, although the pump 510 may generally be sized so that flow along the recirculation line 522 to the pump is as low as possible (e.g., zero, during normal operation).

In contrast, in some examples, an outlet flow from the venturi device 506 may be higher than the capacity of the assist pump 510 (e.g., when warming up the power machine at a low speed). Thus, for example, the recirculation line 522 can be used as a secondary drain line to discharge some of the hydraulic flow from the venturi device 506 to the tank 412 and can thus help to maintain a desired flow rate through the assist pump 510 as well as to route aerated fluid to the inlet of the tank for de-aeration.

Although discussion of the example of FIG. 5 focuses on drainage for the drain case 502, particularly for the drive motor 404, other configurations are possible. For example, two drive motors can be provided in some cases, with one or more corresponding venturi systems for drainage of the associated housing(s) (e.g., with a dedicated venturi system as in FIG. 5 for each separate drain case or drive motor). Further, in some examples, a similar arrangement can be used to remove fluid from other housings (e.g., a drain case 560 for the drive pump 402).

In some implementations, devices or systems disclosed herein can be utilized or configured for operation using methods embodying aspects of the present disclosure. Correspondingly, description herein of particular features, capabilities, or intended purposes of a device or system is generally intended to inherently include disclosure of a method of using such features for the intended purposes, a method of implementing such capabilities, and a method of configuring disclosed (or otherwise known) components to support these purposes or capabilities. Similarly, unless otherwise indicated or limited, discussion herein of any method of manufacturing or using a particular device or system, including configuring the device or system for operation, is intended to inherently include disclosure, as examples of the disclosed technology, of the utilized features and implemented capabilities of such device or system.

Certain operations of methods according to the present disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular implementations of the present disclosure. Further, in some examples, certain operations can be executed in parallel.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Unless otherwise specified or limited, the terms “about” and “approximately,” as used herein with respect to a reference value, refer to variations from the reference value of ±15% or less (e.g., ±10%, ±5%, etc.), inclusive of the endpoints of the range. Similarly, the term “substantially equal” (and the like) as used herein with respect to a reference value refers to variations from the reference value of less than ±30% (e.g., ±20%, ±10%, ±5%) inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

As used herein in the context of power machines, unless otherwise defined or limited, “tractive” or “drive” designate actuators and other work elements of a power machine that can be powered by a power source to cause movement of the power machine over terrain (e.g., wheeled or tracked ground-engaging elements, motors configured to power ground-engaging elements, and related assemblies). In contrast, “workgroup” is used to refer to actuators or other work elements of a power machine associated with powered operation of work elements that are not configured to provide powered travel over terrain (e.g., lift arm structures, attached implements, motors or other actuators to power movement of lift arm structures or attached implements, auxiliary power take-off interfaces, and related assemblies). Thus, tractive (or drive) actuators are arranged to power travel of a power machine whereas workgroup actuators are arranged to power non-travel work operations of the power machine. Correspondingly, discussion of workgroup functions refers to one or more functions provided by movement of one or more workgroup elements of a power machine, whereas discussion of tractive (or drive) functions refer to one or more functions provided for movement of the power machine itself over terrain.

Also as used herein in the context of hydraulic flow, unless otherwise limited or defined, “between” indicates a component or path that is along a flow from a first reference component to a second reference component. For example, a heat exchanger located “between” an upstream pump and a downstream tank may be located so that flow from the pump passes through the heat exchanger to reach the tank. Similarly, as used herein in the context of hydraulic flow, unless otherwise limited or defined, “communication” indicates the ability of hydraulic fluid to flow within a system between particular components. Unless otherwise specified, hydraulic components are not considered to be in communication with each other simply by way of sharing a common tank.

Although the presently disclosed technology has been described with reference to preferred implementations, workers skilled in the art will recognize that changes may be made in form and detail without departing from the scope of the discussion.

1. A hydraulic system for a power machine, the hydraulic system comprising:
a hydrostatic drive motor;
a hydrostatic drive pump in communication with the hydrostatic drive motor via a hydrostatic drive circuit;
a drain case that includes one or more of the hydrostatic drive motor or the hydrostatic drive pump;
a venturi device that includes a main flow inlet in communication with the hydrostatic drive circuit, a main flow outlet, and a suction inlet in communication with the drain case, the venturi device being configured to provide suction to the drain case via the suction inlet during flow of fluid from the main flow inlet to the main flow outlet;
a heat exchanger;
a tank; and
an assist pump that includes an assist pump inlet in communication with the main flow outlet of the venturi device and an assist pump outlet in communication with the heat exchanger, the assist pump being configured to receive flow from the main flow outlet of the venturi device and provide pressurized flow to the tank via the heat exchanger.

2. The hydraulic system of claim 1, wherein the hydrostatic drive circuit includes a shuttle valve in communication with the main flow inlet of the venturi device.

3. The hydraulic system of claim 1, further comprising:
a power source with a rotational output;
wherein the hydrostatic drive motor and the assist pump are commonly powered by the rotational output.

4. The hydraulic system of claim 1, further comprising:
one or more additional pumps;
wherein an outflow from the one or more of the additional pumps is:
in communication with the hydrostatic drive circuit, to provide charge flow to the hydrostatic drive circuit; or
in communication with the main flow inlet of the venturi device, to provide supplemental flow through the venturi device.

5. The hydraulic system of claim 4, wherein the one or more additional pumps includes an auxiliary pump arranged to power a cooling fan for a power source of the power machine.

6. The hydraulic system of claim 5, wherein the one or more additional pumps includes an implement pump arranged to power a hydraulic workgroup actuator of the power machine.

7. The hydraulic system of claim 1, further comprising:
a primary drainage line that extends between the heat exchanger and the tank; and
a recirculation line that extends from the primary drainage line to a location between the assist pump inlet and the main flow outlet of the venturi device.

8. The hydraulic system of claim 1, further comprising:
an implement pump arranged to power a hydraulic workgroup actuator of the power machine; and
a discharge path between the hydraulic workgroup actuator and the tank;
wherein the assist pump inlet is in communication with the discharge path to route a portion of flow from the discharge path through the heat exchanger.

9. A power machine comprising:
a power source;
a hydrostatic drive system that includes:
a hydrostatic drive circuit;
a drive pump powered by the power source;
a drive motor powered by the drive pump via the hydrostatic drive circuit; and
a drain case that includes the drive motor;
a venturi device that includes a main flow inlet, a main flow outlet, and a suction inlet in communication with the drain case;
a heat exchanger;
a tank; and
an assist pump that is powered by the power source and includes: an assist pump inlet supplied by the main flow outlet of the venturi device, and an assist pump outlet in communication with the heat exchanger;
the hydrostatic drive system being configured to supply flow to the main flow inlet of the venturi device, to draw fluid from the drain case via the suction inlet of the venturi device; and
the assist pump being configured to route the fluid drawn from the drain case to the tank, via the heat exchanger.

10. The power machine of claim 9, further comprising:
an auxiliary pump that is powered by the power source and includes: an auxiliary pump outlet, and an auxiliary pump inlet in communication with the tank;
wherein the auxiliary pump outlet is in communication with:
the hydrostatic drive circuit, to provide charge flow for operation of the drive pump and the drive motor; and
the main flow inlet of the venturi device, to provide supplemental flow for generation of suction at the suction inlet.

11. The power machine of either of claims 9 or 10, further comprising:
an implement pump that is powered by the power source and that includes an implement pump inlet in communication with the tank and an implement pump outlet;
wherein the implement pump outlet is in communication with:
the hydrostatic drive circuit, to provide further charge flow for operation of the drive pump and the drive motor; and
the main flow inlet of the venturi device, to provide further supplemental flow for generation of suction at the suction inlet.

12. The power machine of either of claims 9 or 10, further comprising:
an implement pump that is powered by the power source and includes: an implement pump outlet, and an implement pump inlet in communication with the tank;
wherein the implement pump outlet is in communication with the tank and is further in communication with the assist pump inlet in parallel with flow from the main flow outlet of the venturi device.

13. The power machine of claim 9, wherein the power machine is a telehandler.

14. A method of operating a power machine, the method comprising:
operating a hydrostatic drive pump of the power machine to provide pressurized flow of fluid within a hydrostatic drive circuit;
routing a portion of the fluid from the hydrostatic drive circuit to a main flow inlet of a venturi device, to generate suction at a suction inlet of the venturi device and thereby induce fluid from a drain case of the hydrostatic drive circuit to flow from a main flow outlet of the venturi device; and
using an assist pump, pressurizing the flow from the main flow outlet of the venturi device to flow through a heat exchanger to tank.

15. The method of claim 14, further comprising:
operating an auxiliary pump to provide supplemental flow at the main flow inlet of the venturi device.

16. The method of claim 15, wherein the supplemental flow from the auxiliary pump powers a cooling fan for a power source of the power machine, upstream of the main flow inlet of the venturi device.

17. The method of claim 14, further comprising:
operating an implement pump to power an implement of the power machine and provide supplemental flow at the main flow inlet of the venturi device.

18. The method of claim 14, further comprising:
operating an implement pump to power an implement of the power machine and provide supplemental flow at an inlet to the assist pump, without passing through the venturi device.

19. The method of claim 14, wherein the flow from the heat exchanger to the tank flows along a primary drainage line; and
wherein operating the assist pump draws additional flow from the primary drainage line to an inlet of the assist pump, via a recirculation line that supplies the assist pump without passing through the venturi device.
